(19) United States
(12) Patent Application Publication
(10) Pub. No.: US 2014/0112768 A1
(43) Pub. Date: Apr. 24, 2014

(54) FORM-FITTING HOUSING COMPONENT COMBINATION AND METHOD FOR THE MANUFACTURE THEREOF

(71) Applicant: MTU Aero Engines AG, Muenchen (DE)

(72) Inventors: Manfred Feldmann, Eichenau (DE); Janine Sangl, Dachau (DE); Norbert Schinko, Muenchen (DE)

(21) Appl. No.: 14/055,364

(22) Filed: Oct. 16, 2013

(30) Foreign Application Priority Data
Oct. 18, 2012 (EP) EP12189099.0

(51) Int. Cl. F01D 25/24; F16L 13/14

(52) U.S. Cl. CPC F01D 25/24; F16L 13/147
USPC 415/182.1; 285/382.4; 29/450

(57) ABSTRACT

A component combination for a shell of a flow channel (10) of a turbomachine, in particular for a housing of a gas turbine or an aircraft engine, including at least two components, a first component (1) forming a closed ring. The closed ring is axially and/or radially held in a form-fitting manner against at least one second component (2) in relation to the flow channel and is able to be removed from or placed into this position only by elastically deforming the ring without changing the second component; the present invention also includes a method for manufacturing a component combination of this type and a corresponding turbomachine having a component combination of this type.

This claims the benefits of European Patent Application EP 12189099.0, filed Oct. 18, 2012 and hereby is incorporated by reference herein.

The present invention relates to a component combination for a shell of a flow channel of a turbomachine, in particular for a housing of a gas turbine or an aircraft engine, as well as a method for manufacturing a component combination of this type and a turbomachine having a corresponding component combination.

The work leading to this invention has received funding from the European Union's Seventh Framework Programme (FP7/2007-2013) for the Clean Sky Joint Technology Initiative under grant agreement no CSJU-GAM-SAGE-2008-001.

### BACKGROUND

In manufacturing turbomachines such as gas turbines and aircraft engines, many different components which must perform different functions must be connected to each other for a housing structure surrounding the flow channel. In addition to load-bearing housing components, heat protection panels, seals, insulations and their carriers, linings and the like must be connected. In addition to flange connections, bayonet or shrink-fit connections are used, in which, for example, annular components are heated or cooled before joining for the purpose of changing their dimensions. In addition, pin and screw connections are used as well as material flow connections such as welding slotted rings in their final mounting position.

### SUMMARY OF THE INVENTION

The disadvantage of the known connecting techniques is that their manufacture is highly complex, due to the assembly of a large number of components or due to the implementation of additional and often cumbersome operations such as heating, cooling, welding, etc.

It is an object of the present invention to provide a component combination as well as a method for manufacturing a corresponding component combination, in particular with regard to the manufacture of turbomachines, a simple assembly of the components being strived for, while simultaneously ensuring a more secure and defined arrangement of the components.

The present invention provides a component combination for a shell of a flow channel of a turbomachine, in particular for a housing of a gas turbine or an aircraft engine, including at least two components, a first component forming a closed ring, characterized in that the closed ring is axially and/or radially held in a form-fitting manner against at least one second component in relation to the flow channel and is able to be removed from or placed into this position only by elastically deforming the ring without changing the second component.

The present invention also provides a method for manufacturing such a component combination characterized in that the first component in the form of a closed ring and the at least one second component are provided in such a way that the ring is elastically deformed and, in the elastically deformed state, is placed in the form-fitting position in relation to the second component, and the ring is at least partially relaxed in the form-fitting position.

The present invention also provides a turbomachine, in particular a gas turbine or an aircraft engine, having such a component combination.

The present invention is based on the idea that a corresponding component combination or a connection of at least two components, in particular for use in housing structures for turbomachines, such as gas turbines and aircraft engines, may also be brought about by using elastic snap-in connections. This makes it possible to securely and easily situate a first component in the form of a closed ring on a second component in such a way that the first component in the form of the closed ring is held in a form-fitting manner in the axial and/or radial direction in relation to the flow channel, an elastic deformation of the first component (snapping) being necessary to introduce the first component into this form-fitting position or to remove the first component from this form-fitting position, provided that the second component itself is not changed.

For example, the second component may be formed by an outer housing of a turbomachine, such as an aircraft engine, the first component in the form of a closed, annular sheet metal part being held in a form-fitting manner on the second component in the axial and radial directions. However, to reach the form-fitting position or to be removed therefrom, the first component in the form of the closed ring must be elastically deformed to be able to be moved past the form-fitting elements. If a frustoconical housing section is used as the second component and an equally frustoconical sheet metal part is used as the first component, which is to be situated within the housing, the inner sheet metal part may be held, for example, by a tab which protrudes radially and axially from the housing section, so that an axially and radially defined position is provided in combination with the frustoconical shape of the housing and sheet metal part. The sheet metal part may be removed from this position or placed into this position only by elastic deformation of the sheet metal part, the sheet metal part being in the form-fitting position in relation to the second housing component after the elastic deformation is relaxed. The elastic deformation makes it possible to move the first component past the form-fitting elements of the second component. After positioning in the form-fitting position, the elastic deformation may be ended, so that the first component, so to speak, snaps into the form-fitting position.

In addition to a radial and axial form-fitting position, the first component, i.e., for example the inner sheet metal part, may also be fixed only radially or axially and held with the aid of other suitable measures in relation to additional degrees of freedom. It is furthermore possible that the elastically deformable first component, which is to be situated in a form-fitting manner on a second component, is situated not only radially inwardly toward the second component but also radially outwardly toward the second component, so that, for example, the second component may be an inner housing wall and the first component may be a component situated outside the second component.

The second component, on which the first, elastically deformable component is situated with the aid of a form fit, may have a higher strength and/or rigidity than the first component to limit the elastic deformation essentially to the first component. In particular, the second component may be made of a material which has a higher modulus of elasticity than the material from which the first component is manufactured.

The first component may be furthermore elastically tensioned after being introduced into the form-fitting position for the purpose of implementing, for example, a particularly tight abutment against the second component due to the elastic tensioning.

The corresponding component combination is manufactured in such a way that the first component in the form of a closed ring and at least one second component, for example in the form of a housing, are initially provided, after which the ring is elastically deformed and placed in the form-fitting position in relation to the second component in the elastic deformation state. When the ring is situated in the form-fitting position, the ring is at least partially relaxed to be held in the second component in a form-fitting manner.

When introducing the first component into the form-fitting position in relation to the second component, a relative movement of the first and second components may occur, so that the first and/or second component(s) may have a surface coating or treatment which makes it easier for them to slide against each other.

Moreover, the shape and dimensions of the first component and/or of the second component as well as the corresponding choice of material may be selected in such a way that the deformation of the first component for mounting on the second component is purely elastic, and no plastic deformation takes place.

### BRIEF DESCRIPTION OF THE DRAWING

The single attached FIGURE shows a purely schematic representation of a partial cross section of a housing structure of an aircraft engine.

### DETAILED DESCRIPTION

Additional advantages, characteristics and features of the present invention are clarified in the following detailed description of an exemplary embodiment on the basis of the appended FIGURE. However, the present invention is not limited to this exemplary embodiment.

The FIGURE shows a partial cross-sectional view of one part of a housing structure of an aircraft engine having an outer housing part 2, which is situated in an annular manner circumferentially around flow channel 10. Moving and stationary blades are situated in flow channel 10, with the aid of which the gas flow is guided through flow channel 10 and which are driven by the gas flow to compress the air sucked into the turbomachine and to combust it together with the fuel in the combustion chamber to thereby drive the turbomachine. The figure shows one part of a moving blade 9 whose tip rotates in relation to a rub coating 8 which is situated on an inner housing wall 7.

Various components, such as heat protection panels, insulations, sealing panels and the like, are situated between inner housing wall 7 and outer housing 2, individual components performing multiple functions under certain circumstances.

A component combination according to the present invention, including outer housing 2 and an inner sheet metal part 1, is provided in the illustrated housing section. As is apparent from the figure, outer housing 2 as well as sheet metal part 1 have a frustoconical, annular structure, the diameter of housing 2 and that of sheet metal part 1 being expanded from the left side of the diagram to the right side of the diagram. Housing 2 may be constructed from multiple segments which are assembled along the circumference and which together form the annular structure of housing 2. The individual segments may be connected to each other via flange connections (not illustrated) or the like. Housing 2 is furthermore connected to additional housing components downstream and upstream from flow channel 10.

Sheet metal part 1 is also designed as a frustoconical ring, the ring being designed in a single piece as a closed ring.

During assembly, annular sheet metal part 1 is easily insertable in the axial direction into the area of the opening in the housing annular structure having the larger diameter until projections 4, 5 abut sheet metal part 1 on the inside of housing 2.

In the area of the opening having the larger diameter, housing 2 furthermore has an axially and radially protruding projection, on which a shoulder 3 having a radially protruding step is provided.

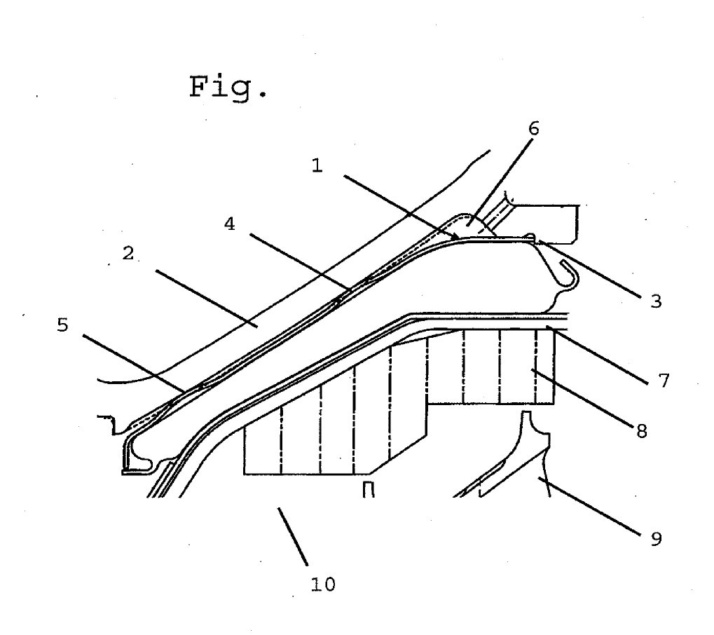

In the illustration in FIG. 1, sheet metal part 1 is already accommodated in a form-fitting position in housing part 2, one end of sheet metal part 1, namely the end having the larger opening diameter, abutting shoulder 3 in the axial direction. To reach this form-fitting position, however, sheet metal part 1 must be elastically deformed, in particular bent. For example, this may be done by pressing sheet metal part 1 on the curvature in the area of the larger opening into a cavity 6 of housing 2, so that the corresponding annular end of sheet metal part 1 slides over shoulder 3 and comes to rest in the area of shoulder 3 after the elastic deformation is relaxed, where it is held in a form-fitting manner.

To enable housing 2 and sheet metal part 1 to slide against each other at the corresponding contact points, for example in the area of the housing projection, during the bending operation, either housing 2 or sheet metal part 1 or both components may be provided with a corresponding surface coating or treatment in such a way that the sliding movement is easily facilitated. A lubricant coating may be provided in the corresponding areas as the simplest method.

After the elastic deformation of sheet metal part 1 has been relaxed, an elastic tensioning of sheet metal part 1 may continue to exist in the form-fitting position, for example by continuing to press sheet metal part 1 against the inside of housing 2 so that projections 4 and 5 may abut the inside of housing 2 in an elastically tensioned manner. This makes it possible to improve the sealing effect of sheet metal part 1.

Although the present invention was described in detail on the basis of the exemplary embodiment, it is as a matter of course to those skilled in the art that the present invention is not limited to this exemplary embodiment, but instead modifications are possible in such a way that individual features may be omitted or different combinations of features may be implemented, provided that this does not depart from the scope of protection of the appended claims. The present invention discloses all combinations of all individual features presented.

What is claimed is:

1. A component combination for a shell of a flow channel of a turbomachine, the component combination comprising:
a first component forming a closed ring; and
at least one second component, the closed ring being at least one of axially and radially held in a form-fitting manner in position against the at least one second component in relation to the flow channel, the closed ring being removable from or placeable into the position only by elastically deforming the closed ring without changing the second component.

2. The component combination as recited in claim 1 wherein the first component is situated radially inwardly or radially outwardly toward the second component.

3. The component combination as recited in claim 1 wherein the second component is constructed from multiple segments.

4. The component combination as recited in claim 1 wherein the first and second components have a frustoconical shape, and the second component has a radially protruding area aiding in the form fitting.

5. The component combination as recited in claim 1 wherein the second component has a at least one of a higher strength and a higher rigidity than the first component.

6. The component combination as recited in claim 1 wherein the second component is manufactured from a second component material having a higher modulus of elasticity than a first component material, the first component manufactured from the first component material.

7. The component combination as recited in claim 1 wherein in addition to the form fitting, the first component is held in the position in an elastically tensioned manner,

8. The component combination as recited in claim 1 wherein at least one of the first and second components is shaped so that an elastic deformation of the first component is possible for removal from or introduction into the position, or at least one of the first and second components has a surface coating or treatment enabling a sliding movement of the first component with respect to the second component.

9. A method for manufacturing the component combination as recited in claim 1, comprising:
elastically deforming the ring;
placing, in the elastically deformed state, the ring in the position in relation to the second component; and
at least partially relaxing the ring in the position.

10. The method as recited in claim 9 further comprising selecting at least one of the group consisting of: dimensions, rigidity, design, and tensile yield point of a material, of at least one of the first and second components, so as to set a deformation of the first component during assembly in such a way that no plastic deformation occurs.

11. A turbomachine comprising the component combination as recited in claim 1.

12. The turbomachine as recited in claim 11 wherein the second component is an outer housing, and the first component is at least one component selected from the group consisting of heating protection panels, insulation carriers, seals and linings.

13. A gas turbine comprising the turbomachine as recited in claim 11.

14. An aircraft engine comprising the turbomachine as recited in claim 11.

15. A housing for a gas turbine or aircraft engine comprising the component combination as recited in claim 1.
